(19) United States
(12) Patent Application Publication
(10) Pub. No.: US 2009/0097692 A1
(43) Pub. Date: Apr. 16, 2009

(54) Screen Speaker System

(75) Inventor: Yoshio Sakamoto, Tokyo (JP)

Correspondence Address: ERIC ROBINSON, PMB 955, 21010 SOUTHBANK ST., POTOMAC FALLS, VA, 20165, US

(73) Assignee: KABUSHIKI KAISHA KENWOOD, Hachiouji-shi (JP)

(21) Appl. No.: 11/919,875

(22) PCT Filed: May 11, 2006
(86) PCT No.: PCT/JP2006/309885

§ 371 Date: Nov. 5, 2007

(30) Foreign Application Priority Data
May 12, 2005 (JP) 2005-139827
Oct. 4, 2005 (JP) 2005-291259

(51) Int. Cl. H04R 1/02; H04R 25/00

(52) U.S. Cl. 381/388; 381/190

(57) ABSTRACT

A screen speaker system (10) includes a screen (12) for projecting a video by a projector and drives the screen (12) to emit audio from the screen (12). The screen speaker system (10) further includes a drive body (50) for driving the screen (12) and at least one piezoelectric element (70) for driving the screen (12) and performing reproduction at a high frequency band than a reproduction frequency band in the drive body (50). It is possible to increase the reproduction frequency band of the screen speaker system without significantly changing the structure.

### TECHNICAL FIELD

The present invention relates to a screen speaker system which emits audio from a screen which projects a screen image which is projected from the external.

### BACKGROUND ART

In recent years, in order to provide a more powerful screen image, a screen for projecting the screen image concerned is enlarged in a home theater system, and an acoustic system which follows it and is full of presence is also requested. In order to meet the request, a 5.1 Channel system which enables to obtain an acoustic effect which is more stereophonic and has further presence than a stereo output is adopted in the acoustic system. In the case of a screen speaker system, audio is emitted from the front of a screen by applying a signal for a center speaker to a voice coil arranged in the center of a screen and applying signals for right and left channels to voice coils arranged in the right and left, with making it correspond to the 5.1 Channel system. As such type screen speaker system, what is disclosed in Japanese Patent Application Laid-Open No. 2005-64932 (FIGS. 21 to 23) is known, for example.

In addition, the present inventor developed a direct drive type screen speaker system which made a screen driven by a drive unit and is disclosed in Japanese Patent Application Laid-Open No. 2005-64932 (FIGS. 10, 17, and 22 to 24). In the direct drive type screen speaker system disclosed in Japanese Patent Application Laid-Open No. 2005-64932 (FIGS. 10, 17, and 22 to 24), a housing is fixed to an arbitrary location on a back side of a screen, and a voice coil is mounted as a drive unit for making the screen driven in a back side of the screen concerned while a magnetic circuit which drives the voice coil is arranged in a housing side.

### DISCLOSURE OF THE INVENTION

In the screen speaker system described in Japanese Patent Application Laid-Open No. 2005-64932, the screen is made to be driven by holding the screen with the housing, dividing the housing concerned into three zones with crosspieces, arranging the voice coil in a back side face of the screen of the divided zones concerned, and arranging in the housing side a magnetic circuit for making the voice coil driven.

Nevertheless, in the screen speaker system described in Japanese Patent Application Laid-Open No. 2005-64932, each of the divided zones is driven by one voice coil. For this reason, it has a defect that a reproduced sound of a high sound area in a reproduction frequency band lacks only with the driving force. In order to cope with this defect, it is inevitable to use side speakers in the right and left of the screen speaker system together so as to compensate the reproduction of the high sound area.

In addition, since upsizing of a screen is requested, side speakers are arranged in positions apart from a center section of the screen when enlarging external dimensions of the screen, and hence, it is not possible to fully compensate reproduction of a high sound area in the center section of the screen as a result. Therefore, it has an issue that the regeneration capacity of the high sound area is insufficient in the center section of the screen.

The present invention was made in view of the issues, and its object is to provide a screen speaker system driven in high-performance and a wide reproduction frequency band.

Then, the present inventor developed a direct drive type screen speaker system which could emit audio in higher bandwidth by mounting piezoelectric loudspeakers in desired positions other than a location, where a voice coil was mounted in a backside of a screen, in the screen speaker, and using the piezoelectric loudspeakers and voice coil together. In consequence, it became possible to obtain the audio in a high bandwidth by using the piezoelectric loudspeakers and voice coil together.

According to an aspect of the present invention, the present invention is a screen speaker system which has a screen to which a screen image is projected by a projector and emits audio from the screen by driving the screen, which is a screen speaker system including a drive unit which drives the screen, and at least one or more piezoelectric elements which are piezoelectric elements, which drive the screen, and perform reproduction in a frequency band higher than a reproduction frequency band in the drive unit.

In a screen speaker system according to the present invention, a drive unit is further constructed of a voice coil and a magnetic circuit, the voice coil and a piezoelectric element have a common input signal, a first signal amplified by a first amplifier is input into the voice coil, a second signal amplified by a second amplifier other than the first amplifier is input into the piezoelectric element, and it is equipped with a filter circuit which passes at least a high frequency side within a frequency band of an input signal in an input side of the piezoelectric element.

A screen speaker system according to the present invention is a screen speaker system in which a filter circuit has a band-pass filter which passes only a predetermined frequency band in a frequency band of an input signal.

Furthermore, in addition, a screen speaker system according to the present invention is a screen speaker system in which an output of the filter circuit is connected to an input of the second amplifier.

A screen speaker system according to the present invention is a screen speaker system in which at least two piezoelectric elements are further connected in parallel to an output side of the second amplifier.

According to another aspect of the present invention, a piezoelectric speaker according to the present invention is a piezoelectric speaker which makes a piezoelectric element drive a diaphragm to emit audio, which is a piezoelectric speaker characterized by including a piezoelectric element which has a through hole in its center or approximate center, a member for fix which has a through or blind screw hole, and a screw for fix for fixing the piezoelectric element to the member for fix, and in that the screw for fix is made to be screwed into the through hole and the screw hole to fasten the piezoelectric element and the member for fix, while the piezoelectric element is mounted on the diaphragm through the member for fix.

According to the present invention, it is possible to provide a screen speaker system performing drive in high-performance and a wide frequency band.

### BRIEF DESCRIPTION OF THE DRAWINGS

FIG. 1 is a perspective view illustrating a screen speaker which relates to a first embodiment of the present invention;

FIG. 2 is a perspective view illustrating a state that a screen is removed from the screen speaker which relates to the first embodiment of the present invention;

FIGS. 3(a) and 3(b) are diagrams illustrating portions near a drive unit which is used for the screen speaker which relates to the first embodiment of the present invention, FIG. 3(a) is a sectional view illustrating a state of disassembling the drive unit, and FIG. 3(b) is a sectional view illustrating a state of assembling the drive unit;

FIG. 4 is a perspective view illustrating a housing of the screen speaker which relates to the first embodiment of the present invention;

FIG. 5 is a perspective view illustrating a back plate which constructs the housing in FIG. 3;

FIG. 6 is an exploded perspective view illustrating a state that the back plate is mounted on a frame member in the housing of the screen speaker which relates to the first embodiment of the present invention;

FIG. 7 is an enlarged view of a portion illustrated by an arrow B in FIG. 6;

FIG. 8 is a partially sectional view of a portion taken on the line K-K in FIG. 1;

FIG. 9 is a perspective view at the time of seeing a magnetic circuit housing, which is illustrated in FIG. 2, from the above;

FIGS. 10(a) and 10(b) are diagrams illustrating construction of a drive unit, FIG. 10(a) is an exploded perspective view before assembling the drive unit, and FIG. 10(b) is a perspective view at the time of seeing the drive unit from the backside of a back plate in a state after assembling it;

FIG. 11 is a sectional view taken on the line N-N in FIG. 1;

FIG. 12 is a schematic diagram illustrating positional relation among voice coils and piezoelectric elements which are used in the screen speaker;

FIG. 13 is a diagram illustrating construction of a drive circuit of the screen speaker system illustrated in FIG. 1;

FIGS. 14(a), 14(b), and 14(c) are graphs illustrating frequency characteristics of the screen speaker system illustrated in FIG. 1, FIG. 14(a) is a graph illustrating a case that the screen speaker system is made to be driven only by the voice coils, FIG. 14(b) is a graph illustrating a case that the screen speaker system is made to be driven only by the piezoelectric elements, and FIG. 14(c) is a graph illustrating a case that the screen speaker system is made to be driven by the drive circuit illustrated in FIG. 13;

FIG. 15 is a diagram illustrating a modified example of a drive circuit of the screen speaker system of the present invention;

FIG. 16 is an exploded perspective view of a piezoelectric speaker which relates to a second embodiment of the present invention;

FIG. 17 is a front view of the piezoelectric speaker which relates to the second embodiment of the present invention;

FIG. 18 is a sectional view of the piezoelectric speaker taken on the line A-A in FIG. 17;

FIG. 19 is an exploded perspective view illustrating construction of a conventional example of the piezoelectric speaker which relates to the present invention; and

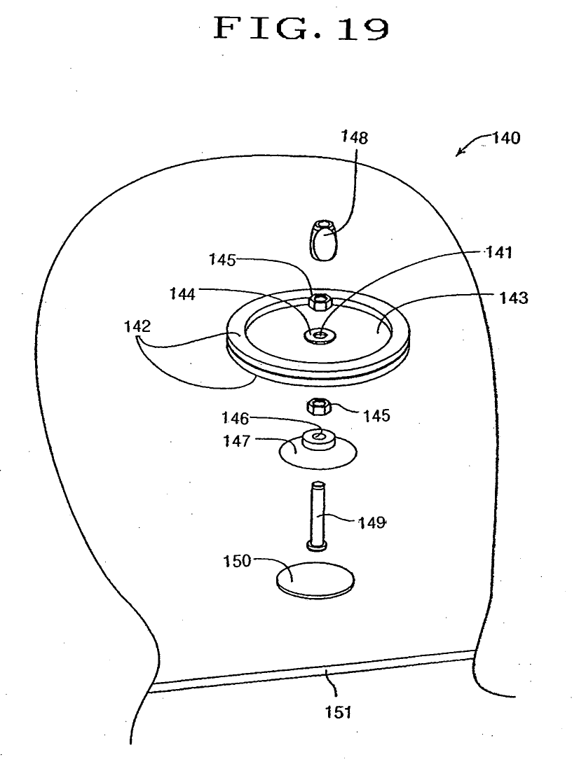

FIG. 20 is a sectional side view illustrating construction of the conventional example of the piezoelectric speaker which relates to the present invention.

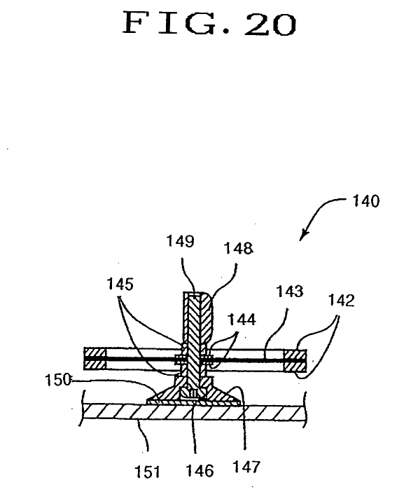

### BEST MODES FOR CARRYING OUT THE INVENTION

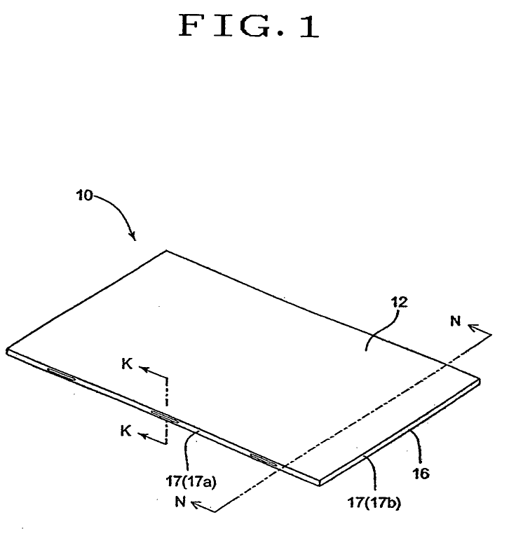

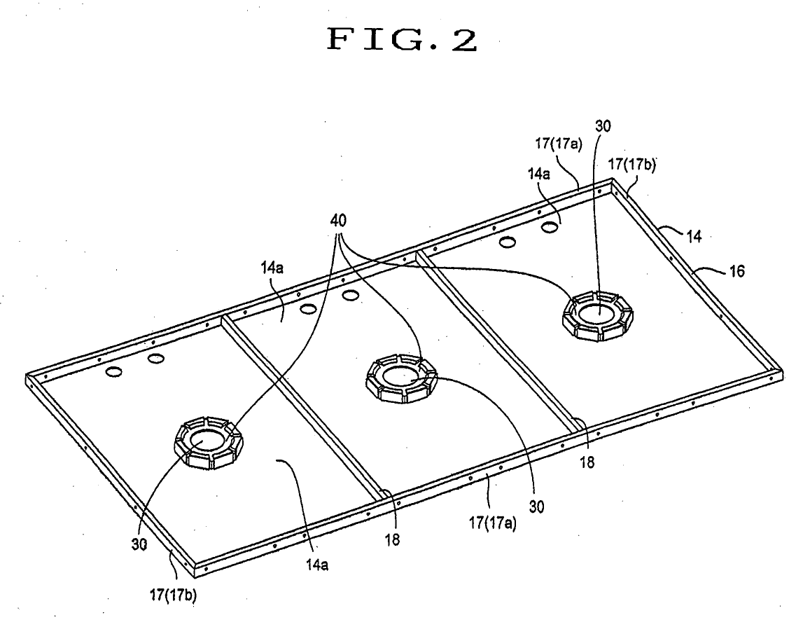

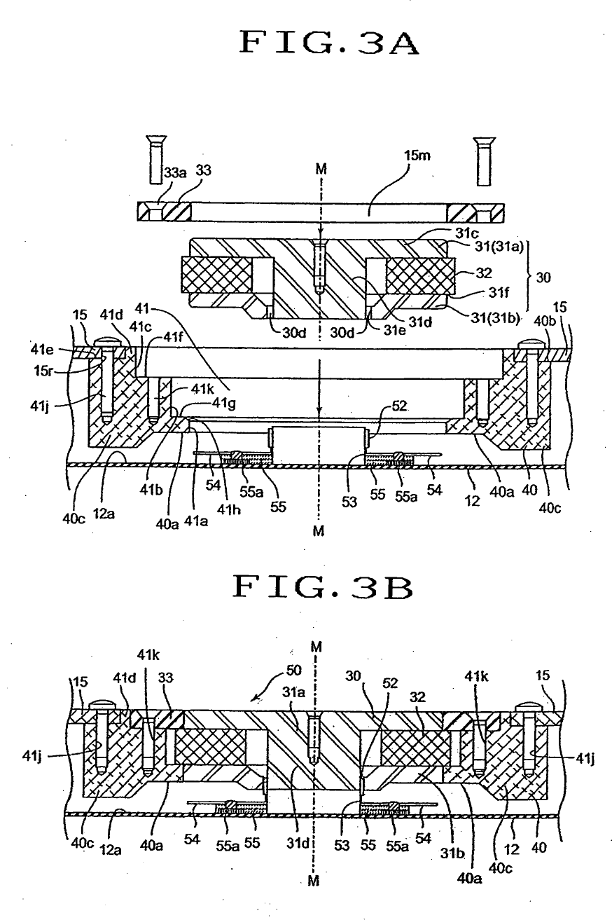

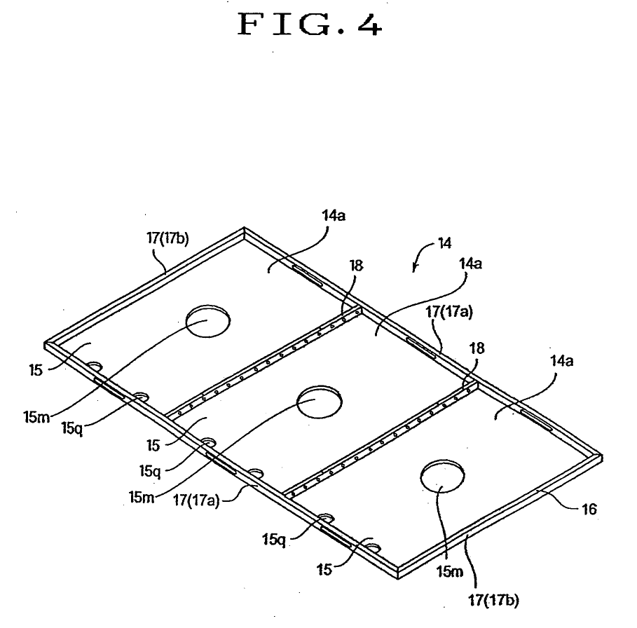

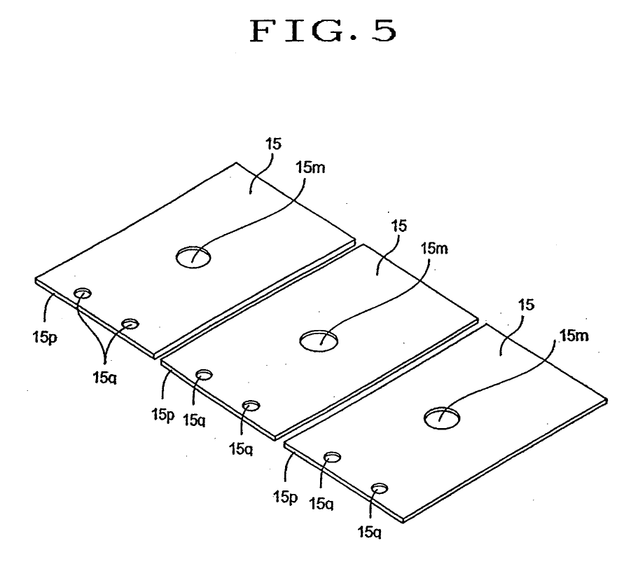

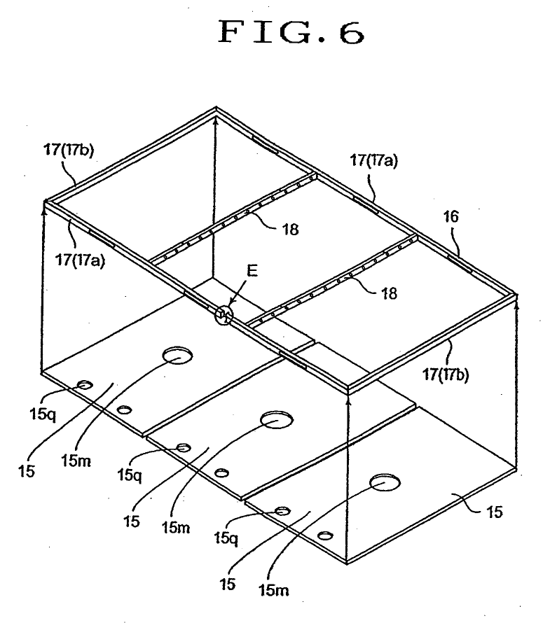

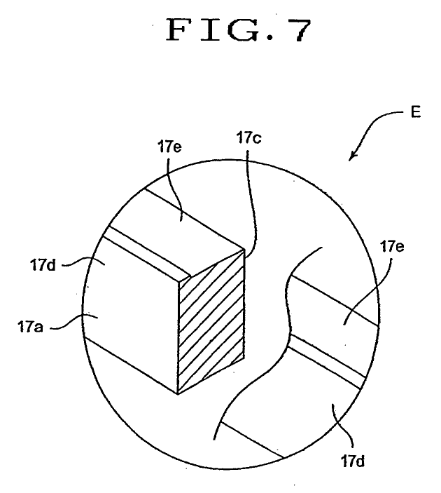

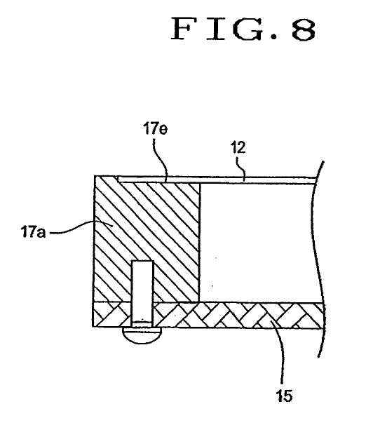

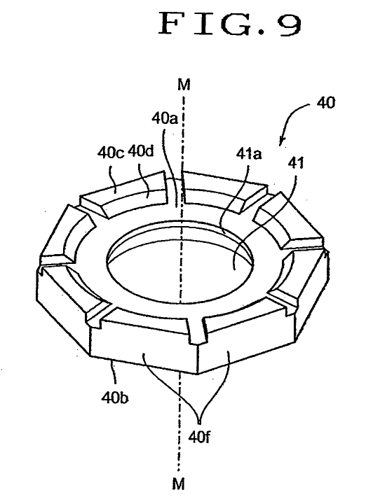

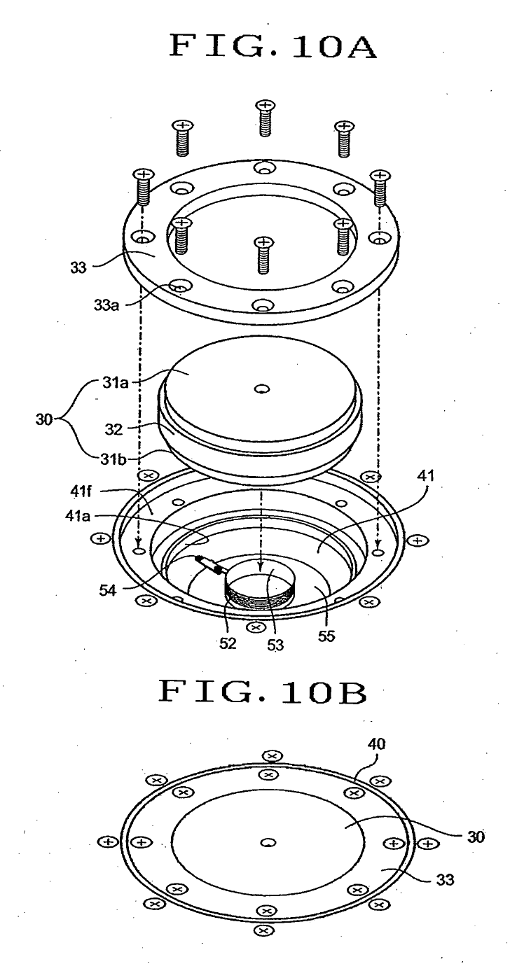

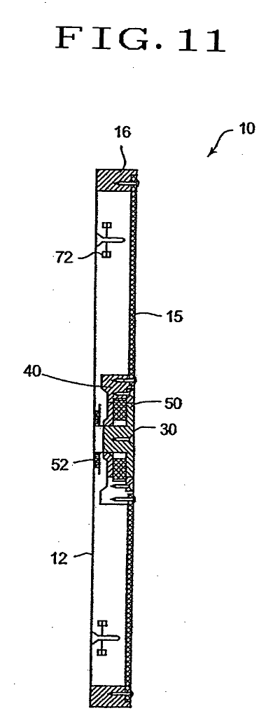

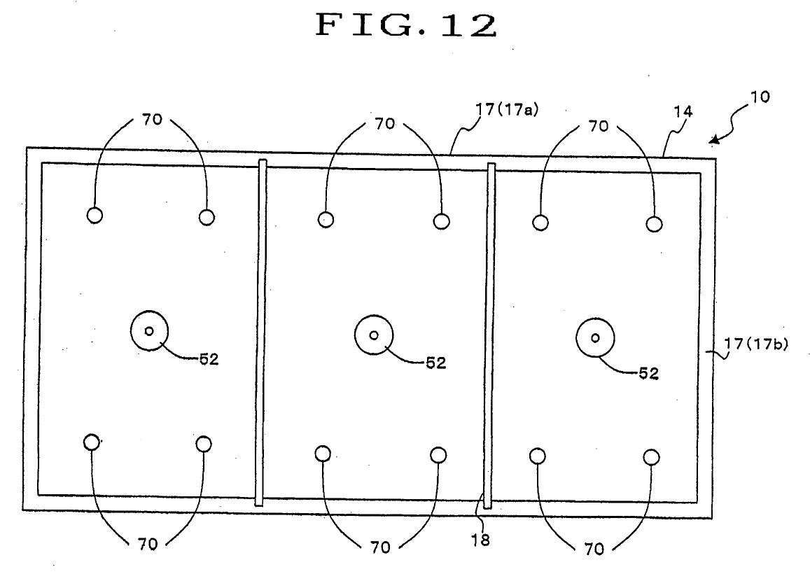

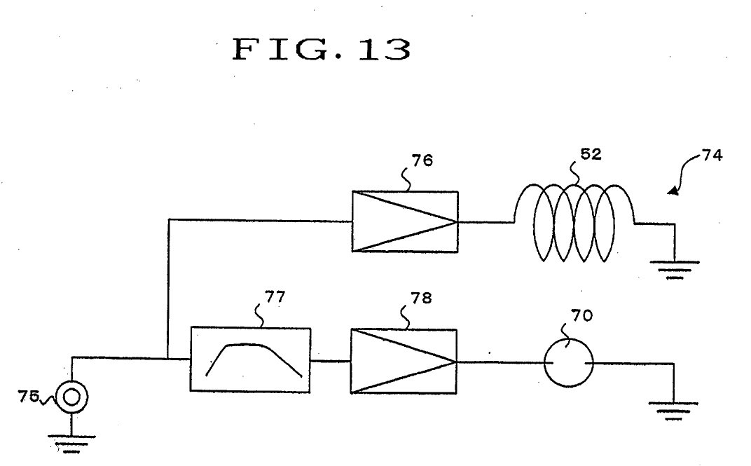

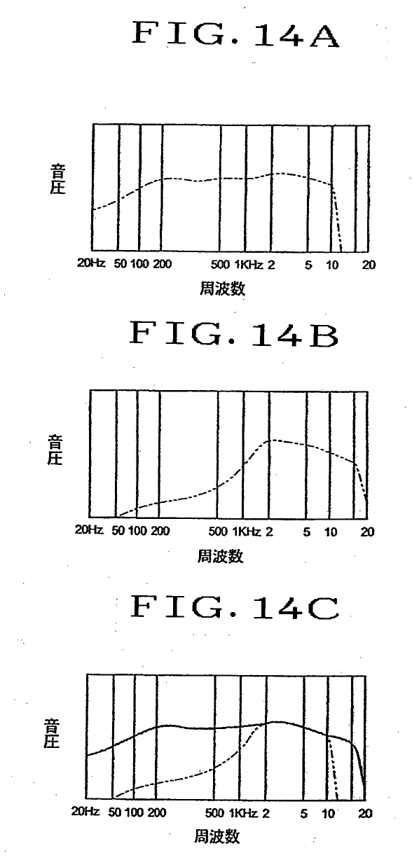

Hereafter, a screen speaker system 10 which relates to a first embodiment of the present invention will be described based on FIG. 1 to FIG. 13. FIG. 1 is a perspective view illustrating the screen speaker system 10 which relates to the first embodiment of the present invention, and FIG. 2 is a perspective view illustrating a state that a screen 12 is removed from the screen speaker system 10. FIGS. 3(a) and 3(b) are diagrams illustrating a portion near a drive unit 50, FIG. 3(a) is a sectional view illustrating a state of disassembling the drive unit 50, and FIG. 3(b) is a sectional view illustrating a state of assembling the drive unit 50. In addition, FIG. 4 is a perspective view illustrating a housing 14 which constructs the screen speaker system 10, and FIG. 5 is a perspective view illustrating a back plate 15 which constructs the housing 14 in FIG. 3. FIG. 6 is an exploded perspective view illustrating a state of mounting a back plate 15 on a frame member 16, and FIG. 7 is an enlarged view of a portion illustrated by an arrow E in FIG. 6. FIG. 8 is a partially sectional view of a portion taken on the line K-K in FIG. 1, and FIG. 9 is a perspective view at the time of seeing a magnetic circuit housing 40 from the above. FIGS. 10(a) and 10(b) are diagrams illustrating construction of the drive unit 50, FIG. 10(a) is an exploded perspective view of the drive unit 50, and FIG. 10(b) is a perspective view at the time of seeing the drive unit 50 from a side of a back plate 15 in a state after assembling it. FIG. 11 is a sectional view taken on the line N-N in FIG. 1. FIG. 12 is a schematic diagram illustrating positional relation among voice coils 52 and piezoelectric elements 70 which are used in the screen speaker 10. FIG. 13 is a diagram illustrating construction of a drive circuit 74 of the screen speaker system 10. FIGS. 14(a), 14(b), and 14(c) are graphs illustrating frequency characteristics of the screen speaker system 10, FIG. 14(a) is a graph illustrating a case that the screen speaker system 10 is made to be driven only by the drive unit 50, FIG. 14(b) is a graph illustrating a case that the screen speaker system 10 is made to be driven only by the piezoelectric elements 70, and FIG. 14(c) is a graph illustrating a case that the screen speaker system 10 is made to be driven by the drive circuit 74. In addition, in FIG. 1, FIG. 4, and FIG. 5, one end side means an upper left direction, and another end side means a lower right direction. In addition, in FIG. 2 and a FIG. 3, one end side shall mean a left-hand side, and another end side shall mean a right-hand side. In addition, in this embodiment, the drive unit 50 which has a magnetic circuit 30 and the voice coil 52 is adopted as a drive unit for making a screen driven, and a magnetic circuit housing 40 for holding the magnetic circuit 30 is adopted as a housing.

As illustrated in FIG. 1, FIG. 2, FIG. 3, and FIG. 12, the screen speaker system 10 is a direct drive type screen speaker system, and is mainly constructed of the screen 12 which projects a screen image from the external, the housing 14 holding the screen 12, the drive unit 50 which vibrates the screen 12, the magnetic circuit 30 which constructs the drive unit 50, the magnetic circuit housing 40 holding the magnetic circuit 30, and the piezoelectric element 70 which vibrates the screen 12 in a higher frequency band in comparison with the drive unit 50.

As illustrated in FIG. 4, the housing 14 is constructed of three sheets of back plates 15, and the frame member 16 surrounding the three sheets of back plates 15 concerned. The back plate 15 is a tabular member which has a rectangular shape, whose core is a lauan, which is a plywood with a thickness of 4 mm in which wormseed is piled on its surface, and on whose surface a 1-mm-thick aluminum plate is further bonded. Hence, the back plate 15 is a plywood with a thickness of 5 mm which has the aluminum plate on the surface. In addition, the frame member 16 is constructed of the side frame 17 used as a frame member which has a rectangular shape, and crosspieces 18 which are arranged along with a narrow direction of the rectangle inside the side frame 17. The side frame 17 and crosspieces 18 each are constructed of a plywood that three sheets of ash material are shaped in arbitrary thickness to be laminated.

As illustrated in FIG. 4, the side frame 17 is arranged up to an outer edge of the back plate 15, and is constructed of two long side frames 17a and 17a which construct a longitudinal direction of the side frame 17 concerned, and two short side frames 17b and 17b which construct a lateral direction of the side frame 17. In addition, a long side frame 17a and a short side frame 17b are illustrated as reference symbols 17 (17a) and 17 (17b) in the figure, respectively. As mentioned above, the two crosspieces 18 are arranged toward the lateral direction inside the side frame 17, and divide a zone inside the side frame 17 into three pieces at equal intervals along with the longitudinal direction. In addition, both the edge faces of the ends of a crosspiece 18 are bonded with the long side frames 17a with an adhesive, and play the role of enhancing strength of the frame member 16 (refer to FIG. 4).

In addition, the frame member 16 is formed by installing the crosspieces 18 inside the side frame 17, and as illustrated in FIG. 6 after that, three sheets of back plates 15 are arranged respectively in a form of covering back sides of the three zones, divided by the crosspieces, from a back side of the frame member 16 concerned. A portion pointed out by an arrow E in FIG. 6 illustrates a sectional shape of the side frame 17. As illustrated in FIG. 7, in a top side of the side frame 17 which is a side in which the screen 12 is mounted to the housing 14, a step section 17e which was given groove processing from an inner peripheral surface 17c of the side frame 17 to a predetermined position on the way to an outer peripheral surface 17d is formed along with the longitudinal direction. A back side of the side frame 17 on which the back plates 15 are installed is a flat face, and is not given processing particularly. In addition, groove portions, which are not illustrated, for the crosspieces 18 to fit in are formed in predetermined positions inside the long side frames 17a.

The screen 12 is installed in a form of being inserted into the step sections 17e provided in the side frame 17. In addition, the back plates 15 are installed in a plurality of locations of the frame member 16 by screwing. As described above, a cross-section of an outer edge portion of the screen speaker system 10 in a state that the screen 12 and the back plates 15 are installed in the frame member 16 is in a state illustrated in FIG. 8.

Furthermore, each insertion hole 15m for inserting inside the screen speaker system 10 a magnetic circuit 30, mentioned later, from a back side of the screen speaker system 10 is provided in a center of each back plate 15 (refer to FIG. 5). In addition, eight mounting holes 15r (refer to FIG. 3) for fixing the magnetic circuit housing 40 for holding the magnetic circuit 30 to the back plate 15 is provided in an outer periphery edge of the insertion hole 15m at intervals of 45 degrees along a circumferential direction. In addition, near a lower end surface 15p in each back plate 15, two holes 15q for terminals are provided so as to become symmetrical to a center line which passes centers of the insertion holes 15m and goes in a lateral direction (refer to FIG. 5). The holes 15q for terminals concerned are holes for arranging a substrate for input terminals for transferring a voltage to a voice coil 52 and a piezoelectric element 70 (not shown). That is, the two holes 15q for terminals are provided in each backside 15.

In this embodiment, as illustrated in FIG. 2, a magnetic circuit housing 40 for holding a magnetic circuit 30 is arranged in each of division sections 14a which are ones divided into three equal volumes by the two crosspieces 18 in the housing 14.

The magnetic circuit 30 is constructed of a holder 31 and a magnet 32 used as a magnetic generation device, as illustrated in FIG. 3(a). The holder 31 is constructed of a mounting holder 31a and a holding holder 31b. In addition, the mounting holder 31a and the holding holder 31b are illustrated as 31 (31a) and 31 (31b) in the figure, respectively. As illustrated in FIG. 3(a), the mounting holder 31a is formed so that a cylindrical section 31d may project toward a lower part in FIG. 3(a) from a center of a blind disc-like bottom 31c. In addition, the holding holder 31b has a shape of having a round hole 31e with the size that the cylindrical section 31d can be inserted into a center of the disc. Then, the ring-like magnet 32 is made to be inserted into the cylindrical section 31d, and the holding holder 31b is made to be inserted into the cylindrical section 31d of the mounting holder 31 from its lower part to latch the magnet 32 to the bottom 31c of the mounting holder 31a. In addition, an air gap section 30d is formed between an inner peripheral surface of the round hole 31e, which is formed in the holding holder 31b, and an outer peripheral surface of the cylindrical section 31d. The magnetic circuit 30 is formed as mentioned above.

The magnetic circuit housing 40 is a support for arranging the magnetic circuit 30 to its inside, and holding the magnetic circuit 30 concerned to the housing 14. In addition, the magnetic circuit housing 40 is fixed to the frame member 16 by being arranged so as to be located above the insertion hole 15m provided in the back plate 15, and being screwed through the mounting hole 15r from the back side of the back plate 15. Since one magnetic circuit housing 40 is arranged to each of the back plates 15, a total of three magnetic circuit housings 40 are arranged inside the housing 14. An external form of the magnetic circuit housing 40 is a regular octahedron whose front is a regular octagon, as illustrated in FIG. 9. In FIG. 9, let an upper face be a top face 40a and let a lower face be a bottom face 40b, and in an outer edge of the top face 40a, a total of eight protrusions 40c are provided with being separated by grooves so as to correspond to respective sides of the regular octagon. Then, inside each of the protrusions 40c, a taper section 40d to form a circumference centering on an axis line M-M of the magnetic circuit housing 40 is formed.

In addition, as illustrated in FIG. 3(a) and FIG. 9, a round hole 41 centering on the axis line M-M is provided in the magnetic circuit housing 40. The round hole 41 is constructed of small-diameter round hole section 41a, a middle-diameter round hole section 41b which is a larger diameter rather than the small-diameter round hole section 41a, and a large-diameter round hole section 41c which is a larger diameter than the middle-diameter round hole section 41b sequentially toward the bottom face 40b from the top face 40a. The large diameter round hole section 41c is substantially formed inside the circumferential protruding section 41d, and an outside of the protruding section 41d has a form of being shaved off over all the circumference. In addition, the shaved-off portion becomes the step section 41e. In the FIG. 3(a), the step section 41e is formed so as to be located upward than a boundary surface 41f used as a boundary between the middle-diameter round hole section 41b and the large-diameter round hole section 41c. In addition, a portion used as a boundary between the small-diameter round hole section 41a and the middle-diameter round hole section 41b becomes a boundary surface 41g. A taper 41h is formed over all the circumference in a corner section where an inner peripheral surface of the small-diameter round hole section 41a and the boundary surface 41g are joined.

Furthermore, eight screw holes 41j are formed in the step section 41e so as to correspond to the mounting holes 15r provided in the back plate 15. Furthermore, eight screw holes 41k are provided in the boundary surface 41f every 45 degrees along a circumferential direction. Each of these screw holes 41k is formed with being shifted by 22.5 degrees to each screw hole 41j along the circumferential direction.

In addition, as illustrated in FIG. 9, the magnetic circuit housing 40 has eight outer peripheral surfaces 40f which form the regular octahedron. In addition, the magnetic circuit housing 40 is made of aluminum, and a distance between sides of the octagon which face each other is 150.8 mm. Nevertheless, the distance concerned is not limited to 150.8 mm.

As illustrated in FIG. 12, three voice coils 52 are arranged in a backside 12a of the screen 12 so as to correspond to positions of the magnetic circuit housings 40. The voice coil 52 constructs a part of the drive unit 50 which drives the screen 12 drive, and is formed by winding a coil wire around a coil bobbin 53 with predetermined dimensions. In addition, as illustrated in a FIG. 3, a terminal flange 55 for fixing an input terminal 54 is installed in the backside 12a of the screen 12. Then, the coil bobbin 53 where the voice coil 52 is wound is mounted into a concave section 55a which is provided in the terminal flange 55. The voice coil 52 is arranged in the backside 12a of the screen 12 as mentioned above. In addition, as illustrated in FIGS. 11 and 12, four piezoelectric elements 70 are arranged in the positions corresponding to the vicinity of four corners of each division section 14a in the backside 12a of the screen 12. That is, a total of 12 piezoelectric elements 70 are arranged in the screen speaker system 10 in every four pieces per each division section 14a.

Furthermore, an input terminal substrate (not illustrated) is mounted into each of two holes 15q for terminals formed in the back plate 15, and lead wires for input signals for being input into the voice coil 52 and the piezoelectric elements 70 (not illustrated), which are installed in the backside 12a of the screen 12, respectively are installed so as to crawl on a surface of the back plate 15. Then, one end of one lead wire (not illustrated) is connected to the input terminal 54 of the voice coil 52, and one end of another lead wire (not illustrated) is connected to an input terminal 72 of the piezoelectric element 70. In addition, another end of each lead wire (not illustrated) is connected to each substrate for an input terminal (not illustrated).

As illustrated in FIG. 3(a), in a state that the magnetic circuit housing 40 is arranged in the housing 14 and the screen 12 is installed in the housing 14, as illustrated in FIG. 3(b), the magnetic circuit 30 is inserted into the round hole 41 of the magnetic circuit housing 40 from the back side of the back plate 15 until corner sections 31f of the magnet 32 abut on the boundary surface 41g of the magnetic circuit housing 40. In this way, the voice coil 52 is arranged inside the air gap section 30d formed in the magnetic circuit 30. Next, in the state that the magnetic circuit 30 is arranged in a predetermined position as described above, a disc-like retainer plate 33 which has a center hole for holding the magnetic circuit 30 concerned is fit into the large-diameter round hole section 41c of the magnetic circuit housing 40 from above the magnetic circuit 30 in FIG. 3. Eight screw holes 33a are provided in the retainer plate 33 in a circumferential direction so as to correspond to the screw holes 41k formed in the magnetic circuit housing 40. For this reason, the retainer plate 33 can be screwed to the magnetic circuit housing 40 in the screw holes 41k by making screws inserted through the screw holes 33a concerned. As mentioned above, as illustrated in FIG. 3(b), the magnetic circuit 30 is contained in the housing 14.

Next, the drive system of the screen speaker system 10 will be described.

As illustrated in FIG. 12, in the screen speaker system 10, a total of three voice coils 52 and 12 piezoelectric elements 70 are arranged in a rate of one voice coil 52 and four piezoelectric elements 70 per each division section 14a. The voice coil 52 not only performs drive in a lower frequency band in comparison with the piezoelectric element 70, but also makes the piezoelectric element 70 driven in a high frequency band (in the following descriptions, making the voice coil 52 driven includes also meaning of making the drive unit 50 driven). In this way, the screen speaker system 10 is driven in a wide frequency band by using the voice coil 52 and the piezoelectric element 70 together.

As for structure of the drive circuit 74 of the screen speaker system 10, as illustrated in FIG. 13, a signal is output from an input unit 75 common to the voice coil 52 and the piezoelectric element 70, and the voice coil 52 and the piezoelectric element 70 are connected in parallel to the input unit 75. After being amplified by a signal amplifier (first amplifier) 76, the signal for the voice coil 52 is input into the voice coil 52. On the other hand, the signal for the piezoelectric element 70 is input into a filter circuit (band-pass filter) 77 which has a high-pass filter and a low-pass filter, and is made to be a suitable frequency band by the filter circuit 77 concerned. Then, the signal output from the filter circuit 77 is input into a signal amplifier (second amplifier) 78, and is amplified by the signal amplifier 78 concerned to be input into the piezoelectric element 70. Here, the filter circuit 77 passes a band in a comparatively high frequency side among frequency bands of an original signal. For this reason, the piezoelectric element 70 is used in a high tone regeneration zone in comparison with the voice coil 52.

In this embodiment, four piezoelectric elements 70 are arranged in the each division section 14a. Hence, in order to make them correspond to the structure of the screen speaker 10, four piezoelectric elements 70 are arranged in the backside 12a of the screen 12, and an input of the each piezoelectric element 70 is connected in parallel to an output of the signal amplifier 78. In addition, one drive circuit 74 is provided to the each division section 14a.

As illustrated in FIG. 14, a frequency characteristic of the screen speaker system 10 exhibits stable output sound pressure in a frequency band of 200 Hz to 10 KHz as illustrated in FIG. 14(a) when only the voice coil 52 is made to be driven. In addition, when only the piezoelectric element 70 is made to be driven, as illustrated in FIG. 14(b), stable output sound pressure is exhibited in a frequency band of 2 KHz to 15 KHz. Then, when these are made to be driven together, as illustrated in FIG. 14(c), comparatively stable output sound pressure is exhibited in a frequency band of 200 Hz to 15 KHz. Hence, in the screen speaker system 10, it becomes possible to improve a frequency characteristic in a high sound area in comparison with a case of making the screen 12 driven only by the voice coil 52 by making the screen 12 driven by using the voice coil 52 and the piezoelectric element 70 together.

In the screen speaker system 10 constructed as described above, it becomes possible to broaden a frequency band in a high frequency side by about 40% in comparison with the case of making it driven only by the voice coil 52, by arranging the piezoelectric element 70 in the backside 12a of the screen 12 and using it together with the voice coil 52. Hence, it is possible to obtain the sound pressure stabilized in the high sound area, and it becomes possible to obtain a stereophonic acoustic effect with full of presence.

In addition, in the screen speaker system 10, it becomes possible to make the screen speaker system 10 driven only by the piezoelectric element 70 without making the voice coil 52 driven in a high sound area.

Furthermore, in the screen speaker system 10, the voice coil 52 is arranged in a position which becomes a center of the each division section 14a in the screen 12. Hence, the voice coil 52 can vibrate vertically to the magnetic circuit 30. Therefore, it is possible to prevent the voice coil 52 from vibrating aslant to the magnetic circuit 30. Hence, it becomes possible to make small dimensions of the air gap section 30d, and to achieve miniaturization of the magnetic circuit 30. Furthermore, the voice coil 52 can obtain large amplitude easily in reproduction of a low-pitched sound region.

Moreover, in the screen speaker system 10, the high sound area is reproduced by making the piezoelectric element 70 driven. In addition, in comparison with a calorific value generated when the voice coil 52 is made to be driven in a high sound area, a calorific value generated when the piezoelectric element 70 is made to be driven in the high sound area is little. Hence, thermal expansion of the screen 12 can be suppressed.

In addition, in the screen speaker system 10, the piezoelectric element 70 is connected in parallel to the voice coil 52, the signal amplifiers 76 and 78 are separately provided to respective input sides of the voice coil 52 and the piezoelectric element 70, and the high sound area is reproduced by the drive of the piezoelectric element 70. Hence, it is possible to adjust the sound pressure and the frequency band of the piezoelectric element 70 separately from the voice coil 52 independently. For this reason, while being possible to enhance driving efficiency, it becomes possible to achieve cost reduction.

As mentioned above, although the first embodiment of the present invention is described, the present invention is variously modifiable besides this. Hereafter, it will be described.

In the above-described first embodiment, although four piezoelectric elements 70 are arranged near the four corners of the each division section 14a to drive the high frequency band, it is not limited to this, and for example, it is sufficient to make the piezoelectric elements 70 arranged in other desired positions such as arranging them circumferentially outside the voice coil 52. In addition, it is also good to make the number of the piezoelectric elements 70 not only four but five or more, and good to make it three or less.

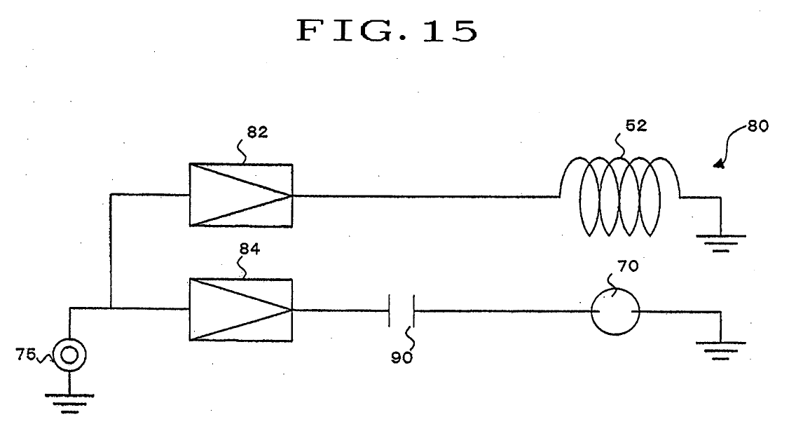

In addition, in the above-described first embodiment, although the drive circuit 74 of a screen speaker system 10 is made to perform driving, it does not limit to this circuitry. For example, as illustrated in FIG. 15, it is also good to adopt a drive circuit 80 having structure that an output of a signal amplifier 82 is connected to an input of the voice coil 52, an output of the signal amplifier 84 concerned is connected to a capacitor 90 and an output of the capacitor 90 is connected to an input of the piezoelectric element 70. In addition, when the screen 12 is made to be driven using the drive circuit 80, since the signal amplifier 84 is provided, it becomes possible to make the input signal to the piezoelectric element 70 amplified separately from the input signal to the voice coil 52 independently. In addition, it is also good to remove low frequency by arranging the filter circuit 77 instead of the capacitor 90.

Furthermore, for example, it is also conceivable to adopt a circuit equipped with a capacitor just before the piezoelectric element 70 while branching an output side of one signal amplifier and connecting the voice coil 52 and the piezoelectric element 70 in parallel, but when a high frequency current is flowed through the piezoelectric element 70 in this circuit, there is a possibility that the piezoelectric element 70 concerned may be broken because impedance of the capacitor concerned is decreased and an excessive current may flow into the piezoelectric element 70. For this reason, it is necessary to be equipped with the signal amplifier 78 separately from the voice coil 52 in an input side of the piezoelectric element 70.

In the above-described first embodiment, although the piezoelectric elements 70 which have the same frequency characteristic wholly are adopted as the four piezoelectric elements 70, it is not limited to this, but it is also good to make structure of the drive circuit 74 into so-called 3-WAY formation, 4-WAY formation, or more by using together the piezoelectric elements 70 which have different frequency characteristics.

In addition, although three division sections 14a are provided inside the housing 14 in the above-described first embodiment, they may be two, or four or more without being limited to this. Furthermore, it is not necessary to divide it. In addition, a plurality of crosspieces 18 are arranged to the lateral direction and longitudinal direction of the side frame 17, and it is also good to make the part, surrounded by only the crosspieces 18, be a division section.

Furthermore, although a suspension function is not given between the screen 12 and the back plate 15 in the above-described first embodiment, it is also good, for example, to arrange a cushioning material, which uses independent expanded rubber and the like as a material, between the screen 12 and the back plate 12. The screen 12 can perform further stable vibration by giving the suspension function between the screen 12 and the back plate 15.

Moreover, although the four piezoelectric elements 70 are connected in parallel to the signal amplifier 78 in the above-described first embodiment, without being limited to this, it is also good to arrange the four signal amplifiers 78 so as to correspond to the number of the piezoelectric elements 70 to connect the piezoelectric elements 70 to the respective signal amplifiers 78. In addition, it is also good to arrange not only the signal amplifiers 78 but also the filter circuits 77 so as to correspond to the number of the piezoelectric elements 70.

Hereafter, a piezoelectric speaker 110 relating to a second embodiment of the present invention will be described with referring to drawings.

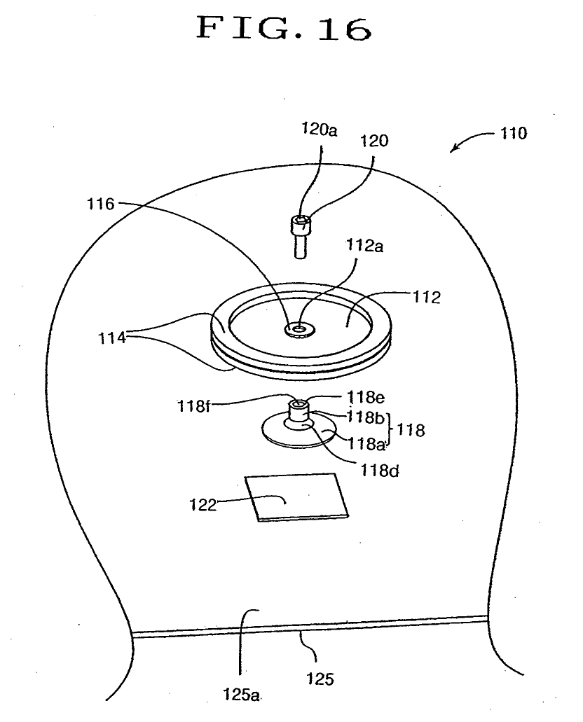

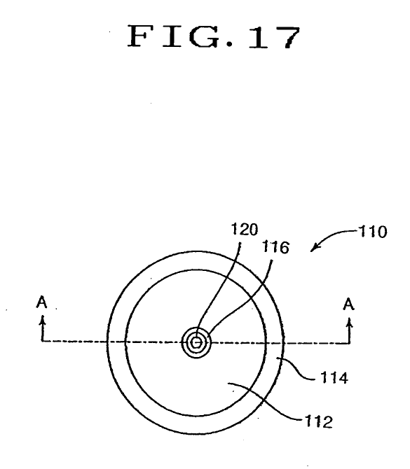

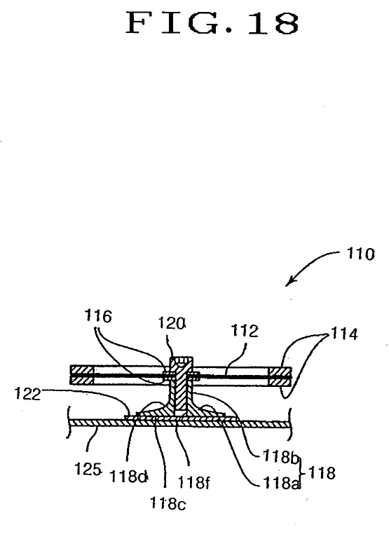

FIG. 16 is an exploded perspective view of the piezoelectric speaker 110 which relates to the second embodiment of the present invention. FIG. 17 is a front view of the piezoelectric speaker 110. FIG. 18 is a sectional view of the piezoelectric speaker 110 taken on the line A-A in FIG. 17.

As illustrated in FIGS. 16 and 18, the piezoelectric speaker 110 is mainly constructed of a piezoelectric element 112 used as a vibrator, vibration control members 114 and 114 for adjusting a vibration characteristic of the piezoelectric element 112, washers 116 and 116 installed on both of top and back faces of the piezoelectric element 112, a fixing member 118 which is used with being made to intervene between the piezoelectric element 112 and a diaphragm 125 for fixing, and a screw for fix, 120 for fixing the piezoelectric element 112 to the fixing member 118.

The piezoelectric element 112 is a member which has a shape of a disc which has a through hole 112a in its center, and deforms according to a voltage applied to its electrode. External dimensions of the piezoelectric element 112 are about 0.3 mm in thickness, and 50 mm in diameter. A diameter of the through hole 112a is about 4 mm. However, the external dimensions of the piezoelectric element 112 and the size of the through hole 112a are not limited to these values.

As illustrated in FIGS. 16 and 17, on outer peripheries in both of the top and back faces of the piezoelectric element 112, the vibration control members 114 and 114 for adjusting the vibration characteristic of the piezoelectric element 112 are installed with an adhesive or the like. The vibration control member 114 is a member with a ring shape which is constructed of an elastic material such as rubber. Although the dimensions of the vibration control member 114 is made to be 40 mm in inner diameter, 50 mm in outer diameter, and 1.5 mm in thickness, it is not limited to these values.

In addition, on outer peripheries of the through hole 112a in both of the top and back faces of the piezoelectric element 112, the washers 116 and 116 made of resin are fixed with an adhesive coaxially on a central axis line of the through hole 112a concerned. The washers 116 play a roll of shock absorbers between the piezoelectric element 112 and the fixing member 118, and the piezoelectric element 112 and the screw for fix, 120 when the piezoelectric element 112 is fastened by the fixing member 118, which is mentioned later, and the screw for fix, 120. Although the dimensions of the washer 116 is made to be 3.2 mm in inner diameter, 8 mm in outer diameter, and 0.8 mm in thickness, it is not limited to these values.

The fixing member 118 is a member for fixing the piezoelectric speaker 110 to the diaphragm 125, and made of aluminum or an aluminum alloy. The fixing member 118 has a disc section 118a with a disc shape which is used as a larger diameter, and a cylindrical section 118b with a cylindrical shape which has a smaller diameter than the disc section 118a, and protrudes upward vertically to a bottom face 118c from an approximate center of the disc section 118a concerned (refer to FIG. 18). As for a sectional shape of the disc section 118a, as illustrated in FIG. 18, it inclines in a divergent shape that a thickness becomes thin gradually toward an outer periphery from an approximate center section where the cylindrical section 118b is formed. In addition, R is formed over the whole circumference in a boundary section 118d which becomes a boundary between the disc section 118a and the cylindrical section 118b. Furthermore, in the fixing member 118, a screw hole 118f size of a nominal bore of which is about 3 mm so as to penetrate the bottom face 118c of the disc section 118a from an end section 118e of the cylindrical section 118b is provided. In addition, the size of the nominal bore of the screw holes 118f is not limited to the above-mentioned value. As dimensions of the fixing member 118, although the size of a diameter of the disc section 118a is 20 mm and a height is 3 mm, and the size of a diameter of the cylindrical section 118b is 8 mm and a height is 2 mm, they are not limited to these values.

The screw for fix, 120 is a metal screw which has a hexagon socket 120a in a head of the screw which has a nominal bore of about 3 mm and a length of 8 mm. As illustrated in FIG. 16, the screw for fix, 120 fastens the piezoelectric element 112 and the fixing member 118 by being inserted into the through hole 112a from above the washer 116 installed in the piezoelectric element 112, and being screwed into the screw hole 118f of the fixing member 118. In addition, since a length of the screw for fix, 120 is 8 mm, in consideration of dimensions of the fixing member 118 and the piezoelectric element 112 in a height direction, a tip of the screw for fix, 120 concerned does not project downward from the bottom face 118c of the fixing member 118.

In addition, the screw hole formed in the head of the screw for fix, 120 is a hexagon socket 120a whose planar shape is an approximately regular hexagon. Therefore, by applying a load only to a circumferential direction, it becomes possible to do a fastening operation of the screw, without applying a load in screwing and unscrewing directions of the screw for fix, 120. Hence, when the fastening operation of the piezoelectric element 112 is done after fixing the fixing member 118 to the diaphragm 125, it becomes possible to fasten the piezoelectric element 112 to the fixing member 118 without applying a load in an amplitude direction of the diaphragm 125. In consequence, it is possible to prevent the diaphragm 125 from being deformed by the fastening operation.

Furthermore, when bonding strength of the piezoelectric element 112 and the fixing member 118 is small and the piezoelectric element 112 vibrates, abnormal noise will arise. Hence, in order to enlarge the bonding strength, what is large is requested as a load applied to the screw for fix, 120. In addition, when fastening is performed using a screw, which has a plus groove or the like, instead of the screw for fix, 120, a load is applied in a direction of the diaphragm 125 at the time of the fastening operation, and, in consequence, the diaphragm 125 will be deformed. Then, although a unit that a load applied to a screw is made small to weaken a fastening force of the piezoelectric element 112 and the fixing member 118, and bonding strength is enhanced using an adhesive or an adhesive material is also considered, when the unit concerned is adopted, not only man-hour increases, but also peeling and leaving operations of the piezoelectric element 112 become hard. Hence, by adopting the screw for fix, 120, which has the hexagon socket 120a, in this embodiment, deformation of the diaphragm 125 at the time of a fastening operation is prevented.

A spacer 122 is a member for fixing the piezoelectric speaker 110 to the diaphragm 125. In addition, the spacer 122 has a square planar shape that a thickness is 1 mm and a length of one side is about 24 mm, and is made of aluminum or an aluminum alloy. As illustrated in FIG. 18, the spacer 122 is arranged between the diaphragm 125 and the fixing member 118, and at the same time, one of its faces is bonded with a backside 125a of the diaphragm 125, and another face is bonded with a bottom face 118c of the fixing member 118, using an acrylic adhesive.

Next, production process and mounting steps of the piezoelectric speaker 110 will be described.

First, vibration control members 114 and 114 are bonded on outer peripheries in both of top and back faces of the piezoelectric element 112 with an adhesive. In addition, on outer peripheries of the through hole 112a in both of the top and back faces of the piezoelectric element 112, the washers 116 and 116 are bonded with an adhesive so as to become coaxial with a central axis line of the through hole 112a concerned.

Next, a screw which has a nominal bore of about 3 mm and a length of about 12 mm is screwed from a side of the end section 118e of the fixing member 118, into the screw hole 118f. The screwing concerned is stopped just before a tip of the screw protrudes from the bottom face 118c of the fixing member 118. That is, it is made to become so that the tip of the screw positions a little upper than the bottom face 118c.

Subsequently, the fixing member 118 in the state that the screw is screwed is mounted in a predetermined location in the backside of the diaphragm 125 through the spacer 122. After the spacer 122 is first bonded with the diaphragm 125 with an acrylic adhesive, the mounting concerned is performed by bonding the bottom face 118c of the fixing member 118 on a surface of the bonded spacer 122 concerned with the acrylic adhesive. Since the screw is screwed into the screw hole 118f in the case of adhesion as mentioned above, it is possible to prevent the adhesive from invading the screw hole 118f.

Next, after removing the screw from the fixing member 118 which is mounted, the piezoelectric element 112 in which the vibration control member 114 and the washer 116 are installed is fastened to the fixing member 118 using the screw for fix, 120. That is, while the screw for fix, 120 is inserted into the through hole 12a of the piezoelectric element 112 from the above, a tip of the screw for fix, 120 protruding downward from the piezoelectric element 112 is screwed into the screw hole 118f of the fixing member 118. When the screw for fix, 120 is screwed, the piezoelectric element 112 is fastened to the fixing member 120 in a state that the tip of the screw for fix, 120 is located a little upper than the bottom face 118c. The screw fastening operation of the screw for fix 120 is done by rotating a tool, such as a hexagonal wrench, which is inserted into the hexagon socket 120a, in a circumferential direction. The piezoelectric speaker 110 is produced as mentioned above, and is mounted on the diaphragm 125.

Subsequently, peeling and leaving steps of the piezoelectric speaker 110 will be described.

First, the screw for fix, 120 is removed from the fixing member 118. Next, a screw, a set screw, or the like which has an effective thread part longer than a depth of the screw hole 118f is screwed into the screw hole 118f. Furthermore, when screwing of the screw is continued, an end section of the screw abuts on a surface (an adhesion surface of the fixing member 118 and the spacer 122) of the spacer 122. Then, although approach of the screw stops, when the screw is further rotated, a force repelled to a driving force of the screw which is going to advance acts on the fixing member 118. That is, a jack up force acts between the fixing member 118 and the spacer 122. Since the jack up force concerned becomes a sufficient force for making the fixing member 118 peeled or left from the surface of the spacer 122, the fixing member 118 peels or leaves from the spacer 122. Since in the case of this embodiment a thickness of the diaphragm 125 is thin and the diaphragm 125 may deform according to the jack up force concerned, the spacer 122 is arranged between the fixing member 118 and the diaphragm 125. However, when the diaphragm 125 has a thickness to the extent of being not deformed to the jack up force, it is not necessary to arrange the spacer 122.

The piezoelectric speaker 110 constructed as described above becomes in the structure of fastening the piezoelectric element 112 to the fixing member 112 by not only making the screw for fix, 120 inserted into the through hole 112a of the piezoelectric element 112, but also making it screwed into the screw hole 118f of the fixing member 118. Hence, the structure of the piezoelectric speaker 110 is simplified and a parts count decreases. In consequence, it is possible not only to exchange the piezoelectric element 112 easily and promptly, but also to achieve reduction of cost of the piezoelectric speaker 110.

In addition, in the piezoelectric speaker 110, since materials of the fixing member 118 and the screw for fix 120 is made to be metal, it becomes possible to fasten the piezoelectric element 112 to the fixing member 118 in a stronger fastening force in comparison with a case that the materials of the fixing member 118 and the screw for fix 120 are made to be resins. Hence, it is possible to prevent effectively abnormal noise from arising in a contact area of the piezoelectric element 112 and the fixing member 118.

Furthermore, in the piezoelectric speaker 110, material of the fixing member 118 and the spacer 122 is made to be aluminum or an aluminum alloy. For this reason, sound wave velocity of vibration from the piezoelectric element 112 becomes fast, and tone quality improves. In addition, since material of the fixing member 118, the spacer 122, and the diaphragm 125 are the same, respective coefficients of thermal expansion also become the same value. Hence, since it becomes difficult to generate skewness between the diaphragm 125 and the piezoelectric speaker 110, tone quality improves. Furthermore, since the aluminum or the aluminum alloy is lightweight and inexpensive, it becomes possible not only to improve the characteristics of the piezoelectric speaker 110, but also to achieve cost reduction.

Moreover, in the piezoelectric speaker 110, the spacer 122 and the fixing member 118, and the spacer 122 and the diaphragm 125 are fixed using an adhesive, respectively. Therefore, in comparison with a case of performing fixture using an adhesive sheet, it becomes possible to fix the diaphragm 125 and the fixing member 118 more firmly, and hence, in consequence, wave transfer efficiency of audio can be improved.

In addition, in the piezoelectric speaker 110, since the fixing member 118 is bonded with the spacer 122 in a state of screwing the screw into the screw hole 118f of the fixing member 118, it is possible to prevent the adhesive from invading the screw hole 118f. Hence, it is possible to prevent the fixing member 118 from being bonded with the spacer 122 in a state that the adhesive exists in the screw hole 118f, and it is possible to prevent that adhesive strength becomes too much large. Hence, it becomes possible to make the fixing member 118 peeled or left comparatively more easily than a mounting surface of the spacer 122.

Although the second embodiment of the present invention is described above, the present invention can be performed in forms which are deformed variously, without limiting to the above-described form.

In the above-described second embodiment, although a planar shape of the piezoelectric element 112 has a disc shape, it is good also to adopt the planar shape as an elliptical or polygonal shape, without limiting to this.

In addition, in the above-described second embodiment, although the spacer 122 is adopted as a member for fixing the piezoelectric speaker 110 to the diaphragm 125, it is also sufficient to install the spacer 122 on the diaphragm 125, and to utilize it as a reinforcing material of the diaphragm 125. In this way, when the diaphragm 125 is utilized as a reinforcing material, it is possible to prevent that the diaphragm 125 deforms easily.

Furthermore, although the screw hole 118f is provided in the above-described second embodiment so as to penetrate the bottom face 118c of the disc section 118a from the end section 118e of the cylindrical section 118b, for example, when performance of the piezoelectric speaker 110 concerned improves to the extent of that maintenance of the piezoelectric speaker 110 is unnecessary or a mounting position of the piezoelectric speaker 110 does not need to be changed, it is also good to make the screw hole 118f be a blank screw hole which does not penetrate the bottom face 118c.

Moreover, in the above-described embodiment, although the screw for fix, 120 is made to be a screw with a hexagon socket which has the hexagon socket 120a on a head, without being limited to this, it is also good, for example, to make it be another kind of screw which can be fastened by applying load in a circumferential direction of a screw such as a hexagon head screw.

### INDUSTRIAL APPLICABILITY

The screen speaker of the present invention can be used in an acoustic transformer, such as a speaker which emits audio from a whole surface of a screen. In addition, the piezoelectric speaker of the present invention can be used in an acoustic transformer which achieves wide band reproduction which used a piezoelectric element.

1. A screen speaker system which has a screen, to which a screen image is projected by a projector, and emits audio from the screen by driving the screen, characterized by comprising a drive unit which drives the screen, and at least one or more piezoelectric elements which are piezoelectric elements, which drive the screen, and perform reproduction in a frequency band higher than a reproduction frequency band in the drive unit.

2. The screen speaker system according to claim 1, characterized in that not only the drive unit includes a voice coil and a magnetic circuit, but also the voice coil and the piezoelectric element have a common input signal, a first signal amplified by a first amplifier is input into the voice coil, a second signal amplified by a second amplifier other than the first amplifier is input into the piezoelectric element, and it is equipped with a filter circuit which passes at least a high frequency side within a frequency band of the input signal in an input side of the piezoelectric element.

3. The screen speaker system according to claim 2, characterized in that the filter circuit has a band-pass filter which passes only a predetermined frequency band among frequency bands of the input signal.

4. The screen speaker system according to claim 2, characterized in that an output of the filter circuit is connected to an input of the second amplifier.

5. The screen speaker system according to claim 2, characterized in that the at least two or more piezoelectric elements are connected in parallel in an output side of the second amplifier.

6. A piezoelectric speaker which emits audio by making a piezoelectric element drive a diaphragm, characterized by comprising:
a piezoelectric element which has a through hole in a center or an approximate center;
a fixing member which has a screw hole which is penetrated or not;
a screw for fixing the piezoelectric element to the fixing member, wherein the screw for fix is made to be screwed into the through hole and the screw hole to fasten the piezoelectric element and the fixing member, while the piezoelectric element is mounted on the diaphragm through the fixing member.

7. The piezoelectric speaker according to claim 6, characterized in that a spacer with a desired thickness is arranged between the fixing member and the diaphragm.

8. The piezoelectric speaker according to claim 6, characterized in that material of the fixing member and the screw for fix is metal.

9. The piezoelectric speaker according to claim 7, characterized in that material of the spacer is metal.

10. The piezoelectric speaker according to claim 7, characterized in that at least either of the fixing member and the spacer is made of aluminum or an aluminum alloy.

11. The piezoelectric speaker according to any of claim 6, characterized in that the screw for fix is a threadably fit screw by applying a force only in a circumferential direction of the screw.
